(19) United States
(12) Patent Application Publication
(10) Pub. No.: US 2007/0024224 A1
(43) Pub. Date: Feb. 1, 2007

(54) kW-based torque control for AC motors

(76) Inventor: Raymond G. McDonald, New Milford, PA (US)

Correspondence Address: Wendy W. Koba, PO Box 556, Springtown, PA, 18081, US

(21) Appl. No.: 11/189,309

(22) Filed: Jul. 26, 2005

(51) Int. Cl. H02P 7/00

(52) U.S. Cl. 318/432; 318/430

(57) ABSTRACT

A kW-based torque controller for use with an AC induction motor has been developed that includes an AC-to-DC converter for receiving incoming three-phase power from a utility and converting the three-phase AC signal to a DC signal, a DC-AC inverter, coupled to the output of the AC-to-DC converter for transforming the DC input signal into a variable frequency/variable phase output signal (the output signal from the DC-AC converter being applied as the input signal to the AC induction motor), and a load sensing unit coupled between a load connected to the motor and the DC-AC inverter for measuring changes in the kW load condition at the motor and providing control signals to the DC-AC inverter to adjust the torque accordingly.

### TECHNICAL FIELD

The present invention relates to a control system for AC motors and, more particularly, to a feedback control system that senses the kW load on the motor and adjusts the motor's torque to provide cost savings in the operation of the motor.

### BACKGROUND OF THE INVENTION

Motor manufacturers have taken steps to improve the efficiency of motors, and this has resulted in NEMA Design E induction motors. Variable Speed Drive (VSD) products have addressed the fact that motors sometimes perform useless work during idle periods. However, there is not yet a design that automatically matches the torque of a motor to the load it is driving. In accordance with the present invention, a device has been developed that provides this torque matching, thus providing a significant amount of energy savings when the motor is under-used or idle.

There are many induction motor applications where the motor is sized to meet a given torque demand that exists for as little as 20% (or less) of the motor's operating time. The escalator is one exemplary application where the motor size must be selected to accommodate “full load” conditions, which may occur only 20% of the time.

To address this problem, some manufacturers have developed “variable speed drive” (VSD) motors, that are designed to maintain a constant torque under all working conditions, by varying the speed the of the motor through adjusting the applied voltage. Unfortunately, if the voltage is increased too high for a given frequency, the kW will raise as a result of the increased iron losses, the rotor will saturate and the machine will come to a stop. If the voltage is lowered for a given frequency, to the extent that the motor torque is less than that required, the rotor will slip, the kW will rise as a result of rotor and stator copper losses, and the rotor will lock.

Existing VSD technology can only be applied to some operations with great difficulty. In particular, VSD systems do not use feedback from the motor to sense the load. The VSD is synchronized to the actions of the machine with a switch to indicate the start of a cycle. The VSD controller is programmed to follow the cycle of the machine in order to lower/raise the RPM of the motor at the appropriate time—that is, just before the machine needs a motor running at full speed. Of course, the program must be changed to reflect the requirements of each job placed on the machine. Synchronization can be lost, resulting in consequent production losses. Additionally, a technical person familiar with programming systems must be readily available to change the motor's program to meet the production requirements.

While raising and lowering the motor's speed using VSD reduces the useless work an induction motor performs while idle, such a system does not address the fact that the induction motor is performing this operation under full torque conditions. There remains significant “iron losses” and “copper losses” in the motor when it is operating at less than 25% load. Moreover, there are situations where lowering the speed of the motor when idle is considered to be inappropriate. For example, reducing the speed of an escalator is not desirable, due to safety concerns.

Most variable speed drive arrangements do not use feedback from the motor to control the drive. Rather, the drive arrangement is configured to maintain a constant ratio of voltage to frequency so as to maintain constant torque at all speeds. However, if too high a voltage is applied to the field coil, an unacceptably high current will be induced in the rotor, causing it to magnetically saturate, loose its magnetic field and stop. If too high of a load is applied to the rotor for the magnetic field induced by the field coil, then the rotor will not rotate but lock in position.

There are a number of other “energy saving” products available today for use in appliances, such as refrigerators. These products use the “power factor” (PF) as a feedback control factor to save energy. However, such arrangements cannot be used on a split phase motor of the capacitor start/capacitor run variety, since such a motor reflects a constant PF (0.98) back along the line.

Thus, a need remains in the prior art for an energy saving arrangement suitable for use with any type of induction motor.

### SUMMARY OF THE INVENTION

The need remaining in the prior art is addressed by the present invention, which relates to a control system for AC motors and, more particularly, to a feedback control system that senses the kW load on the motor and adjusts the torque to provide cost savings in the operation of the motor.

In accordance with the present invention, a high voltage, high current converter (i.e., a three-phase AC to DC converter) and following inverter are used to drive the induction motor. The kW load on the motor is measured and used as a feedback signal that is applied to the inverter to adjust the torque to match the current load conditions.

It is an advantage of the present invention that the kW-based torque driver can be retro-fitted to existing motors, thus extending the life of the motor and allowing the motor to operate at cooler temperatures.

In an alternative embodiment of the present invention, a bypass arrangement can be used in association with the kW-based torque controller that functions to turn “off” the kW-based torque controller when certain process conditions occur that would damage the motor or halt the process.

Other and further advantages of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates, in block diagram form, an exemplary kW-based torque controller formed in accordance with the present invention;

FIG. 2 is a graph of torque as a function of motor speed/slip;

FIG. 3 contains a profile of load vs. time demand for an exemplary machine utilizing the kW-based torque controller of the present invention; and

FIG. 4 is a block diagram of an alternative embodiment of the present invention, including the use of a bypass arrangement.

### DETAILED DESCRIPTION

Motor manufacturers have taken steps to improve the efficiency of motors, and this has resulted in NEMA Design E induction motors. Variable Speed Drive (VSD) products have addressed the fact that motors sometimes perform useless work during idle periods. However, there is not yet a design that automatically matches the torque of a motor to the load it is driving. In accordance with the present invention, a device has been developed that provides this torque matching, thus providing a significant amount of energy savings when the motor is under-used or idle.

There are many induction motor applications where the motor is sized to meet a given torque demand that exists for as little as 20% (or less) of the motor's operating time. The escalator is one exemplary application where the motor size must be selected to accommodate “full load” conditions, which may occur only 20% of the time.

The kW-based torque controller of the present invention functions to provide real-time feedback from the motor, thereby eliminating the need to provide synchronization to each different process. The kW-based torque controller addresses not only the losses associated with useless work performed while using VSD, but also the losses associated with excessive torque. The use of a kW-based torque drive arrangement, in accordance with the present invention, can potentially reduce the use of electricity in the range of 25-30%.

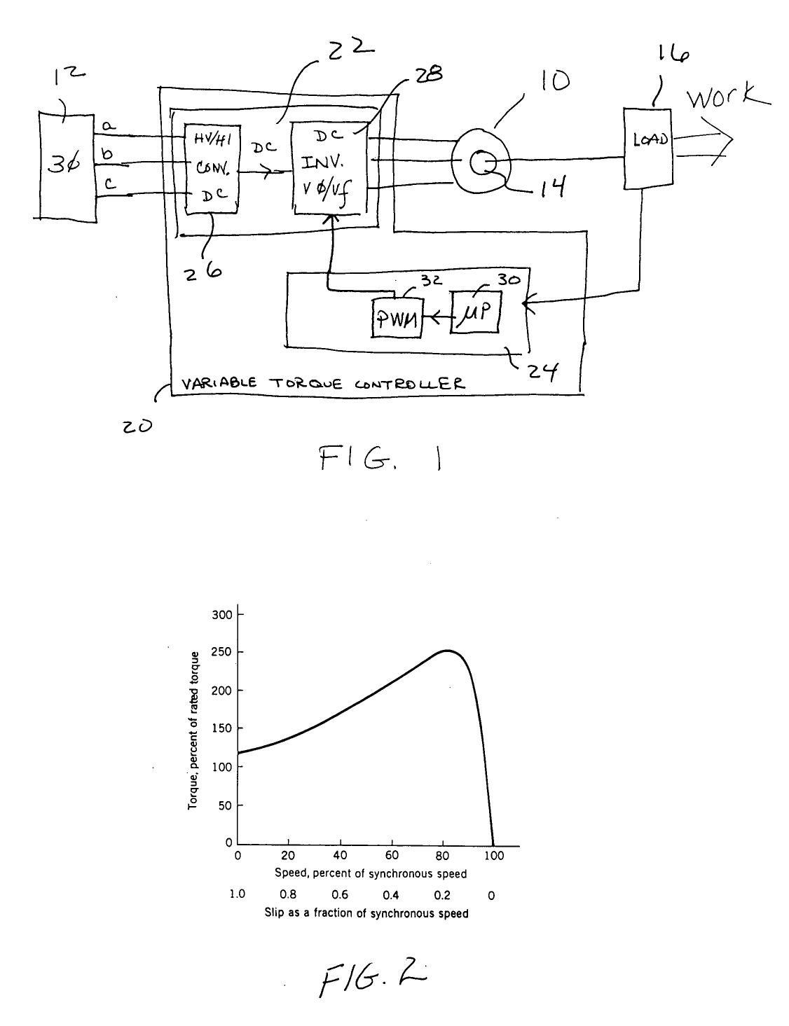

FIG. 1 illustrates an exemplary polyphase (in this case, three phase) induction motor 10 that is configured to include a kW-based torque controller arrangement 20 formed in accordance with the present invention. In conventional arrangements, induction motor 10 would directly receive its input power from an electrical power grid element 12, which produces three-phase power along lines a, b, and c as shown. Once power is applied to induction motor 10, its rotor 14 will begin to rotate and thus be able to drive a load 16. Load 16 may encompass a variety of different applications, with induction motors use to actuate, for example, conveyors, escalators, injection molding machines, dryer fans, and more. As mentioned above, when an induction motor is sized for a variable load, the size selected must accommodate the maximum load required by the application. Thus, it follows that the selected motor size is oversized for lower loads of the application (which may, in fact, be the majority of cases). There are three broad categories for applications where motors are used: (1) the actual load is “constant”, but the motor used is oversized, resulting in a low power factor; (2) the actual load is constant, but varies from time to time as the process varies, the motor being oversized as the load varies; and (3) the motor is used in processes where the actual load varies continually due to the process, and sometimes there is no load.

In accordance with the present invention, it has been found that by monitoring the load being driven by an induction motor, the torque applied to the motor can be adjusted so as to eliminate the waste of “work” done by the motor and realize a significant savings in kW (and thus electrical utility costs). In particular, a kW-based torque controller 20 of the present invention comprises a power block 22 disposed between electrical power grid element 12 and induction motor 10 and a load sensing feedback unit 24, which is coupled back to power block 22. As shown, power block 22 includes an AC to DC converter 26 that functions to convert the incoming high voltage/high current three phase power from electrical power grid element 12 into a DC signal. This DC output signal from converter 26 is then used as a power input to a DC to Variable phase/Variable frequency inverter 28. The feedback signal from load sensing unit 24 is also applied as an input to inverter 28. As is known in the art, an inverter in such power arrangements is used to transfer energy from a DC source (such as the output of converter 26) to an AC load of arbitrary frequency and phase. Inasmuch as phase/frequency inverter 28 is capable of modifying either the phase or frequency of a DC signal and form a three-phase output signal, the torque of the output signal applied to induction motor 10 can be adjusted as well.

Load sensing unit 24 includes, in this particular embodiment, a microprocessor 30 responsive to measurements in the load value. Microprocessor 30 includes various design data and tables that can be used to translate the measured load value into the appropriate torque value for maximum motor efficiency. The torque value output from microprocessor 30 is applied as an input to a pulse-width modulated (PWM) switching engine 32 that is used to set the switching speed for the devices (for example, IGBTs) used as a control to inverter 28. Other arrangements for load sensing unit 24 are possible, and are considered to fall within the scope of the present invention. For example, a digital signal processor may be used to evaluate the changes in load and provide the changed driving circuit values to inverter 28.

FIG. 2 contains a curve illustrating the change in torque (illustrated as % of rated torque) as a function of “slip”, measured as a fraction of synchronous speed. Torque can be defined as the tendency for two magnetic fields to line up in much the same way as bar magnets tend to align themselves. As shown in the graph of FIG. 2, the torque will continue to increase with increasing slip, up to a maximum value, and then fall off to zero. In the normal operating range of an induction motor, as the external load (such as load 14 of FIG. 1) increases, the rotor impedance will also increase, necessitating a high slip value for a desired operation condition.

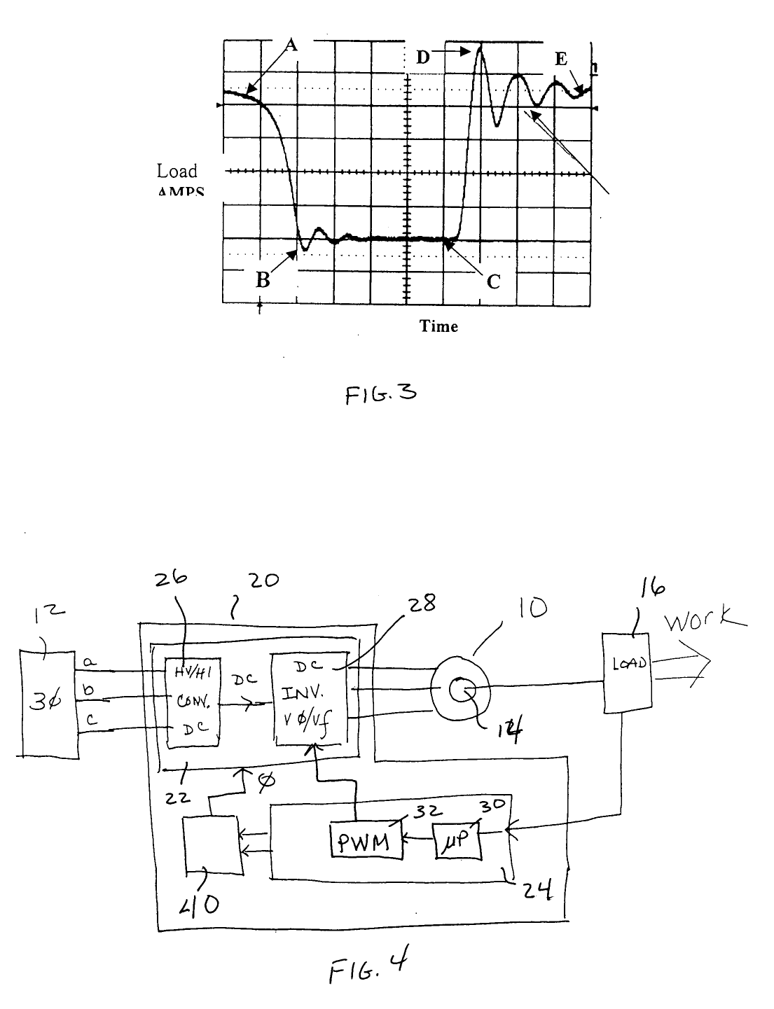

The profile of load vs. time demands for an exemplary induction motor (in this case, simulating a die casting machine) utilizing the kW-based torque controller of the present invention is illustrated in FIG. 3. Point A of the profile is defined as the point in time when the motor is in a “dwell” mode, during a cycle doing useless work. In accordance with the present invention, once load sensing unit 24 measures a “no load” (i.e., OkW) condition, the torque is reduced and the power drops to point B, as shown. The motor continues in the dwell period until the process requires full torque, at point C. Once load sensing unit 24 realizes that a “load” is present, the power increases and torque is increased. The kW-based torque controller of the present invention detects the need for full torque and responds instantly to raise the torque to point D. The response time in this particular experimental arrangement was 15 ms, far less than the typical 150 ms response time of most conventional motors.

FIG. 4 illustrates an alternative embodiment of the present invention that includes an automatic bypass system 40. Upon occasion, there may develop problems with the use of the motor that would be injurious to the process (or the motor), if the torque is allowed to vary uncontrollably. Automatic bypass system 40 is utilized to monitor a set of parameters such as, for example, amps, volts, temperature, vibration or other customer-specified parameters, and will automatically turn off kW-based torque controller 20 should any of these parameters be detected. Further, automatic bypass system 40 may be configured to generate an “alarm” signal, alerting a maintenance engineer to the existence of a problem. By virtue of turning off kW-based torque controller 20, the motor is permitted to continue operating (without the ability to adjust the torque), a preferred result to having the motor shut down.

While the invention has been described in terms of its preferred embodiments, it should be understood that numerous modifications may be made thereto without departing from the spirit and scope of the invention as defined by the claims appended hereto.

What is claimed is:

1. A kW-based torque controller for use with an AC induction motor, the controller comprising:
an AC-to-DC converter for receiving incoming three-phase power from a utility and converting the three-phase AC signal to a DC signal;
a DC-AC inverter, coupled to the output of the AC-to-DC converter for transforming the DC input signal into a variable frequency/variable phase output signal, the output signal from the DC-AC converter being applied as the input signal to the AC induction motor; and
a load sensing unit coupled between a load connected to the motor and the DC-AC inverter for measuring changes in the kW load condition at the motor and providing control signals to the DC-AC inverter to adjust the torque accordingly.

2. A kW-based torque controller as defined in claim 1 wherein the load sensing unit further comprises
a microprocessor for receiving the measured kW load value and generating therefrom the proper torque condition values; and
a pulse-width modulator switching unit, coupled to the output of the microprocessor for using the torque condition values to determine the switching control signal to be applied to the DC-AC inverter, where the output of the pulse-width modulator switching unit is applied as the control input to the DC-AC inverter.

3. A kW-based torque controller as defined in claim 1 wherein the controller further comprises
an automatic bypass system coupled to the AC-DC converter and the DC-AC inverter, the automatic bypass system used for monitoring a plurality of system alarm parameters and turning off the converter and inverter if an alarm condition occurs.

4. A kW-based torque controller as defined in claim 3 wherein the plurality of alarm parameters includes system amperage, voltage, temperature and vibration.

5. A kW-based torque controller as defined in claim 3 wherein the automatic bypass system is further capable of generating an audible alarm signal if an alarm condition occurs.
